(19) United States
(12) Patent Application Publication
(10) Pub. No.: US 2025/0308544 A1
(43) Pub. Date: Oct. 2, 2025

(54) AUDIO SCENE MODIFICATION

(71) Applicant: Nokia Technologies Oy, Espoo (FI)

(72) Inventor: Arto Juhani LEHTINIEMI, Tampere (FI)

(21) Appl. No.: 19/077,489

(22) Filed: Mar. 12, 2025

(30) Foreign Application Priority Data
Mar. 27, 2024 (GB) 2404370.5

(51) Int. Cl. G10L 21/034; G06F 3/01; H04N 23/61

(52) U.S. Cl. CPC G10L 21/034; G06F 3/015; G06F 3/017; H04N 23/61

(57) ABSTRACT

Various example embodiments are disclosed relating to modifying at least part of an audio scene, for example modifying output and/or capture of at least part of an audio scene based on a measured neural activity of a user. For example, a method may comprise measuring neural activity of a user during output and/or capture of an audio scene and identifying, based on the measured neural activity, at least one target audio source of the audio scene which has the auditory attention of the user. The method may further comprise causing modification of the output and/or capture of at least part of the audio scene based on the identification.

### FIELD

Various example embodiments relate to modifying at least part of an audio scene, for example modifying output and/or capture of at least part of an audio scene based on a measured neural activity of a user.

### BACKGROUND

A user may hear an audio scene in different ways. For example, the user may participate in a communications session involving one or more other participants, wherein the audio scene comprises audio of the other participants which may be output such that they will be perceived at different respective positions with respect to the user. In another example, an audio scene may comprise a real-world audio scene which comprises one or more audio sources. The user may select to capture the real-world audio sources using one or more microphones of a user device. In any such situation, a particular participant or real-world audio source may have the user's auditory attention.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus, comprising: means for measuring neural activity of a user during output and/or capture of an audio scene; means for identifying, based on the measured neural activity, at least one target audio source of the audio scene which has the auditory attention of the user; and means for causing modification of the output and/or capture of at least part of the audio scene based on the identification.

In some example embodiments, the modifying may comprise, during output of the audio scene, emphasizing output of audio associated with the at least one target audio source relative to audio associated with one or more other audio sources of the audio scene.

In some example embodiments, the emphasizing may comprise amplifying the audio associated with the at least one target audio source relative to the audio associated with the one or more other audio sources of the audio scene.

In some example embodiments, the emphasizing may comprise attenuating the audio associated with the one or more other audio sources relative to the audio associated with the at least one target audio source of the audio scene.

In some example embodiments, the audio scene may comprise a plurality of audio sources and wherein audio associated with the plurality of audio sources is output such that the audio sources will be perceived at different respective positions with respect to the user. In some example embodiments, the modifying may comprise, during output of the audio scene, attenuating audio associated with a background audio source in a direction which corresponds to the position of the at least one target audio source. In some example embodiments, the audio associated with the background audio source may be captured by the apparatus or a capture device associated with the apparatus during output of the audio scene.

In some example embodiments, the audio scene may comprise a plurality of audio sources and may be received as part of a communications session in which the plurality of audio sources represent respective participants of the communications session.

In some example embodiments, the audio scene may be a real-world audio scene in which audio associated with one or more audio sources of the audio scene may be captured by the apparatus or a capture device associated with the apparatus.

In some example embodiments, the apparatus may further comprise means for determining, during capture, a direction of the at least one target audio source with respect to the user, wherein the modifying may comprise providing or steering a sound capture beam towards the direction of the at least one target audio source such as to amplify audio coming from the direction of the at least one target audio source relative to audio coming from the direction of one or more other audio source(s) of the real-world audio scene.

In some example embodiments, the apparatus may further comprise means for capturing, via a camera of the apparatus, an image of the real-world audio scene, means for displaying the captured image, means for determining, based on the direction of the at least one target audio source with respect to the user, a sub-portion of the captured image corresponding to the at least one target audio source, and means for modifying the determined sub-portion and/or causing the camera to focus on the determined sub-portion.

In some example embodiments, the apparatus may further comprise means for capturing, via a camera of the apparatus, an image of the real-world audio scene, means for displaying the captured image, means for determining, based on the direction of the at least one target audio source with respect to the user, that the captured image does not include the at least one target audio source, and means for changing a lens of the camera such that the captured image will include the at least one target audio source.

In some example embodiments, the apparatus may further comprise means for identifying a predetermined trigger gesture of the user, wherein at least the modifying is performed responsive to identifying the predetermined trigger gesture.

In some example embodiments, the predetermined trigger gesture may be identified based at least in part on the measured neural activity of the user when said predetermined trigger gesture is performed. The predetermined trigger gesture may comprise a predetermined type of eye movement.

In some example embodiments, the apparatus may further comprise means for determining respective confidence values associated with a plurality of audio sources of the audio scene, wherein the confidence value associated with a particular audio source indicates a likelihood that the particular audio source has the auditory attention of the user, and wherein the at least one target audio source is identified, based at least in part, on the respective confidence values.

In some example embodiments, the apparatus may further comprise means for identifying an ambiguity between two or more of the audio sources having the highest respective confidence values based on said respective confidence values being within a predetermined range of one another, and means for resolving the ambiguity based on further measured neural activity to identify which of the two or more identified audio sources is the target audio source.

In some example embodiments, the apparatus may further comprise means for, responsive to identifying the ambiguity, outputting a reference sound in the direction of at least one of the two or more identified audio sources, wherein resolving the ambiguity may comprise identifying, based on measured neural activity when the reference sound(s) is or are played to the user, which of the two or more identified audio sources is the target audio source.

In some example embodiments, the apparatus may further comprise means for, responsive to identifying the ambiguity, requesting a directional gesture towards the position of the target audio source, wherein the directional gesture may be determined based on the measured neural activity of the user when said directional gesture is performed. The directional gesture may comprise eye movement towards the target audio source.

In some example embodiments, the apparatus may further comprise means for measuring, based on the measured neural activity, a time period over which the at least one target audio source has the auditory attention of the user, wherein the modifying may be performed by an amount based on the measured time period.

In some example embodiments, the apparatus may be comprised by an earphones device comprising one or more sensors for sensing biosignals of the user for measuring the user's neural activity.

In some example embodiments, the apparatus may be comprised by a user device in communication with an earphones device.

According to a second aspect, there is described a method, comprising: measuring neural activity of a user during output and/or capture of an audio scene; identifying, based on the measured neural activity, at least one target audio source of the audio scene which has the auditory attention of the user; and causing modification of the output and/or capture of at least part of the audio scene based on the identification.

In some example embodiments, the modifying may comprise, during output of the audio scene, emphasizing output of audio associated with the at least one target audio source relative to audio associated with one or more other audio sources of the audio scene.

In some example embodiments, the emphasizing may comprise amplifying the audio associated with the at least one target audio source relative to the audio associated with the one or more other audio sources of the audio scene.

In some example embodiments, the emphasizing may comprise attenuating the audio associated with the one or more other audio sources relative to the audio associated with the at least one target audio source of the audio scene.

In some example embodiments, the audio scene may comprise a plurality of audio sources and wherein audio associated with the plurality of audio sources is output such that the audio sources will be perceived at different respective positions with respect to the user.

In some example embodiments, the modifying may comprise, during output of the audio scene, attenuating audio associated with a background audio source in a direction which corresponds to the position of the at least one target audio source. In some example embodiments, the audio associated with the background audio source may be captured by the apparatus or a capture device associated with the apparatus during output of the audio scene.

In some example embodiments, the audio scene may comprise a plurality of audio sources and may be received as part of a communications session in which the plurality of audio sources represent respective participants of the communications session.

In some example embodiments, the audio scene may be a real-world audio scene in which audio associated with one or more audio sources of the audio scene may be captured by a capture device.

In some example embodiments, the method may further comprise determining, during capture, a direction of the at least one target audio source with respect to the user, wherein the modifying may comprise providing or steering a sound capture beam towards the direction of the at least one target audio source such as to amplify audio coming from the direction of the at least one target audio source relative to audio coming from the direction of one or more other audio source(s) of the real-world audio scene.

In some example embodiments, the method may further comprise capturing, via a camera of the apparatus, an image of the real-world audio scene, displaying the captured image, determining, based on the direction of the at least one target audio source with respect to the user, a sub-portion of the captured image corresponding to the at least one target audio source, and modifying the determined sub-portion and/or causing the camera to focus on the determined sub-portion.

In some example embodiments, the method may further comprise capturing, via a camera of the apparatus, an image of the real-world audio scene, displaying the captured image, determining, based on the direction of the at least one target audio source with respect to the user, that the captured image does not include the at least one target audio source, and changing a lens of the camera such that the captured image will include the at least one target audio source.

In some example embodiments, the method may further comprise identifying a predetermined trigger gesture of the user, wherein at least the modifying is performed responsive to identifying the predetermined trigger gesture.

In some example embodiments, the predetermined trigger gesture may be identified based at least in part on the measured neural activity of the user when said predetermined trigger gesture is performed. The predetermined trigger gesture may comprise a predetermined type of eye movement.

In some example embodiments, the method may further comprise determining respective confidence values associated with a plurality of audio sources of the audio scene, wherein the confidence value associated with a particular audio source indicates a likelihood that the particular audio source has the auditory attention of the user, and wherein the at least one target audio source is identified, based at least in part, on the respective confidence values.

In some example embodiments, the method may further comprise identifying an ambiguity between two or more of the audio sources having the highest respective confidence values based on said respective confidence values being within a predetermined range of one another, and resolving the ambiguity based on further measured neural activity to identify which of the two or more identified audio sources is the target audio source.

In some example embodiments, the method may further comprise outputting, responsive to identifying the ambiguity, a reference sound in the direction of at least one of the two or more identified audio sources, wherein resolving the ambiguity may comprise identifying, based on measured neural activity when the reference sound(s) is or are played to the user, which of the two or more identified audio sources is the target audio source.

In some example embodiments, the method may further comprise requesting, responsive to identifying the ambiguity, a directional gesture towards the position of the target audio source, wherein the directional gesture may be determined based on the measured neural activity of the user when said directional gesture is performed. The directional gesture may comprise eye movement towards the target audio source.

In some example embodiments, the method may further comprise measuring, based on the measured neural activity, a time period over which the at least one target audio source has the auditory attention of the user, wherein the modifying may be performed by an amount based on the measured time period.

In some example embodiments, the method may be performed by an earphones device comprising one or more sensors for sensing biosignals of the user for measuring the user's neural activity.

In some example embodiments, the method may be performed by a user device in communication with an earphones device.

According to a third aspect, there is described a computer program product, comprising a set of instructions which, when executed on an apparatus, is configured to cause the apparatus to carry out a method, comprising: measuring neural activity of a user during output and/or capture of an audio scene; identifying, based on the measured neural activity, at least one target audio source of the audio scene which has the auditory attention of the user; and causing modification of the output and/or capture of at least part of the audio scene based on the identification.

In some example embodiments, the third aspect may include any other feature mentioned with respect to the method of the second aspect.

According to a fourth aspect, there is described an apparatus comprising at least one processing core, at least one memory including computer program code, the at least one memory and the computer program code being configured to, with the at least one processing core, cause the apparatus to: measure neural activity of a user during output and/or capture of an audio scene; identify, based on the measured neural activity, at least one target audio source of the audio scene which has the auditory attention of the user; and cause modification of the output and/or capture of at least part of the audio scene based on the identification.

In some example embodiments, the fourth aspect may include any other feature mentioned with respect to the method of the second aspect.

### DRAWINGS

Example embodiments will be described, by way of non-limiting example, with reference to the accompanying drawings, in which:

FIG. 1 illustrates a system useful for understanding example embodiments;

FIG. 2A illustrates a side view of an earphones device that may comprise part of the FIG. 1 system;

FIG. 2B illustrates the FIG. 2A earphones device when located on a user's ear;

FIG. 3 illustrates a model for identifying auditory attention of a user in accordance with some example embodiments;

FIG. 4 is a flow diagram illustrating operations that may be performed in accordance with some example embodiments;

FIG. 5A illustrates a front view of a user when listening to an audio scene;

FIG. 5B illustrates a first way in which output of the FIG. 5A audio scene may be modified in accordance with some example embodiments;

FIG. 5C illustrates a second way in which output of the FIG. 5A audio scene may be modified in accordance with some example embodiments;

FIG. 6 illustrates how audio capture of one or more real-world audio sources may be modified in accordance with some example embodiments;

FIG. 7A illustrates a rear view of a user when listening to a real-world audio scene;

FIG. 7B illustrates how audio capture of part of the FIG. 7A audio scene may be modified in accordance with some example embodiments;

FIG. 8A illustrates a rear view of a user when using a user device including a camera;

FIG. 8B illustrates how audio and/or video capture by the FIG. 8A user device may be modified in accordance with some example embodiments;

FIG. 9 is a block diagram of an apparatus that may be configured in accordance with one or more example embodiments; and

FIG. 10 illustrates a non-transitory computer readable medium in accordance with one or more example embodiments.

### DETAILED DESCRIPTION

Disclosed herein are various example embodiments relating to modifying output and/or capture of at least part of an audio scene based on measured neural activity of a user.

The audio scene may comprise a plurality of audio sources. An audio source may comprise any entity that emits audio, i.e., audible sounds. An audio source may therefore comprise a person, animal, musical instrument, a loudspeaker, a vehicle, or weather. Such examples are not intended to be limiting.

Example embodiments may involve identifying, based on measured neural activity of the user during output and/or capture of an audio scene, which audio source of a plurality of audio sources has a user's auditory attention. In other words, which audio source is the user currently listening to. The identified audio source may be referred to as a target audio source. Depending on the situation, certain processing functions may be performed based on this identification.

The audio scene may, for example, comprise an audio scene that is output or rendered to the user via loudspeakers of an earphones device.

For example, the audio scene may represent part of a communications session in which the plurality of audio sources represents respective participants. The identified target audio source may correspond to a participant whose audio (audio signal) the user is currently listening to; hence it may be appropriate to emphasize audio corresponding to that participant. In this way, the audio of the target audio source may be made clearer and/or more intelligible.

In another example, the audio scene may comprise a real-world audio scene external to the user. The real-world audio scene may comprise audio sources such as one or more of the above examples. In situations where the user captures at least some of the real-world audio scene via their headphones device or an associated user device, it may be appropriate to emphasize capture of audio corresponding to the target audio source. In this way, the captured audio of the target audio source may be clearer and/or more intelligible when recorded and played back.

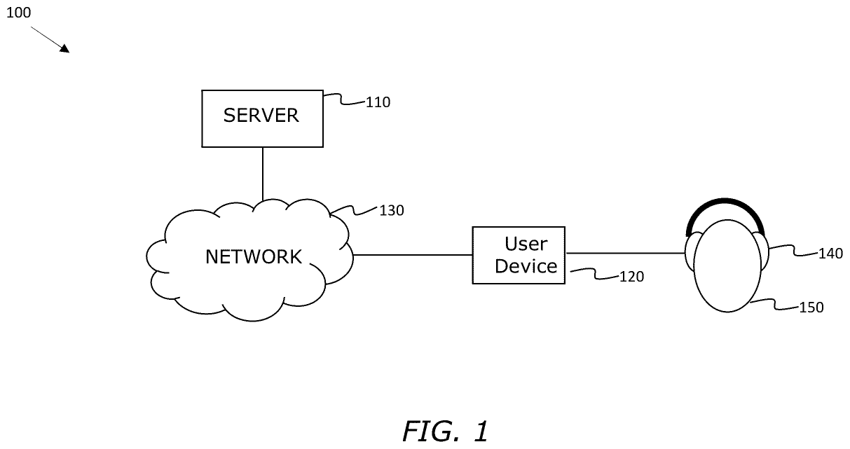

FIG. 1 is a block diagram of a system 100 which may be useful for understanding example embodiments.

The system 100 may comprise a server 110, a user device 120, a network 130 and an audio output device comprising, in this example, an earphones device 140 worn by a user 150.

The earphones device 140 may comprise any form of head-worn audio output device, such as a pair of earphones, earbuds, headphones or an extended reality (XR) headset. In such cases, audio data may be output to left and right-hand loudspeakers thereof using monaural, stereo or (in the case of spatial audio data) binaural rendering.

The server 110 may be connected to the user device 120 by means of the network 130 for sending audio data to the user device. The server 110 may for example comprise an internet protocol (IP) telecommunications server which transmits audio data comprising part of a communications session voice to the user device 120. The communications session may, for example, comprise a voice call which may involve one or more participants other than the user 150. The audio data may comprise spatial audio data encoded with a spatial percept such that, when decoded and output to the earphones device 140, the one or more participants will be perceived at different respective positions with respect to the user 150 in a resulting audio scene.

Example formats for spatial audio data may include, but are not limited to, multi-channel mixes, Ambisonics, parametric spatial audio (e.g., metadata-assisted spatial audio (MASA)), object-based audio, or any combination thereof. The spatial audio data may be encoded and decoded using a codec which may comprise, but is not limited to, the 3GPP Immersive Video and Audio Services (IVAS) format.

Transmission may be by means of any suitable streaming data protocol. Alternatively, or additionally, the server 110 may provide one or more files representing audio data to the user device 120 for storage and processing thereat. The audio data may for example represent a music track or audio associated with a video clip or movie.

At the user device 120, the audio data may be processed, rendered and output to the earphones device 140.

In some example embodiments, the user device 120 may comprise one of, but is not limited to, a mobile telephone, a tablet computer, a games console, a laptop computer, a personal computer, a vehicle navigation computer, or wearable device. The user device 120 may communicate with the earphones device 140 by means of a short-range communications channel such as Bluetooth, Zigbee, WiFi, or similar. The user device 120 may comprise one or more cameras.

The network 130 may be any suitable data communications network including, for example, one or more of a radio access network (RAN) whereby communication with the user device 120 is via one or more base stations, a WiFi network whereby communications is via one or more access points, or a short-range network such as one using the Bluetooth or Zigbee protocol.

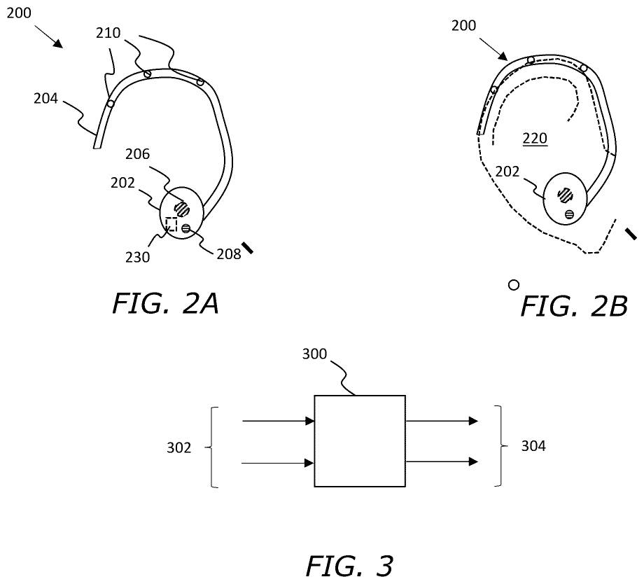

FIG. 2 illustrates a first earphone 200 of the earphones device 140. It will be appreciated that a second earphone (not shown) of the earphones device may comprise the same or similar features.

The first earphone 200 may comprise a first portion 202 and a second portion 204.

The first portion 202 may comprise a body which carries a loudspeaker 206 which, in use, locates over or partly within a user's ear canal. The first portion 202 may optionally carry a microphone 208 for capturing audio external to the user 150. For example, audio captured by the microphone 208 may be processed as part of an active noise cancellation (ANC) algorithm.

The first portion 202 may also comprise a processing module 230 which may be configured to perform various operations to be described below. The first portion 202 may also comprise one or more radio transceivers for communications with the user device 120.

The second portion 204 may comprise a curvilinear arm which extends from the first portion 202 and locates, in use, around an outer portion of a user's ear 220, as shown in FIG. 2B.

The second portion 204 may comprise one or more sensors 210 which contact respective parts of the user's skin, located behind the ear 220. Alternatively, or additionally, the first portion 202 may comprise one or more sensors which contact respective parts of the user's skin.

The one or more sensors 210 may sense or pick-up biosignals (sometimes referred to as bioelectrical signals) produced by the user's brain during some form of activity. In example embodiments, the activity may comprise output of an audio scene or listening to a real-world audio scene whilst capturing at least part of that real-world audio scene.

Biosignals may comprise signals produced by living beings that can be measured and monitored. Such biosignals may, for example, represent the change in electric current produced by a sum of an electrical potential difference across a particular tissue, organ or cell system. For example, so-called Electroencephalography (EEG) signals may be picked-up by the one or more sensors 210 to provide an electrogram of electrical activity of the user's brain in a non-invasive way.

The biosignals picked-up by the one or more sensors 210 may be provided to the processing module 230.

Alternatively, the processing module 230 may be provided at the user device 120 in which case the picked-up biosignals may be transmitted by the first earphone 200 to the user device.

Biosignals may also be picked-up by one or more sensors of a second earphone (not shown) which biosignals may be transmitted to the first earphone 200 or to the user device 120 device which comprises the processing module 230.

The processing module 230 may comprise, or be configured to access, a machine learning (ML) model.

FIG. 3 illustrates an example ML model 300. The ML model 300 may comprise, but is not limited to, an artificial neural network (ANN). There are various known types of ANN, including feed-forward neural networks, perceptron neural networks, convolutional neural networks, recurrent neural networks, deep neural networks, and so on. Each type may be more appropriate for a particular application or task.

According to some example embodiments, the ML model 300 may be configured to receive the picked-up biosignals as inputs 302, which may be digitized and possibly pre-processed, for measuring neural activity of the user 150 during output and/or capture of at least part of an audio scene. The ML model 300 may also be configured to receive as input audio data that represents at least part of the audio scene which is output by the loudspeaker 206. The audio data may represent part of communications session or audio track. The ML model 300 may alternatively or additionally, depending on the use case, also be configured to receive audio data that represents at least part of the real-world audio scene that surrounds the user and which is captured by the one or more microphones 208.

The ML model 300 may be configured, based on the received biosignals, and the received audio data, to identify an audio source of the audio scene which has the auditory attention of the user, i.e., the target audio source. For example, the ML model 300 may produce one or more outputs 304 which identify the target audio source and/or assign respective probability values to the plurality of audio sources, wherein the target audio source may be that which is assigned the highest probability value. In cases where two or more probability values are relatively close to one another, other actions may be performed for confirming the target audio source, to be described later on. For example, the ML model 300 may be configured in accordance with a so-called auditory attention inference system described in Haghighi M, Moghadamfalahi M, Akcakaya M, Erdogmus D. EEG-assisted Modulation of Sound Sources in the Auditory Scene. Biomed Signal Process Control. 2018 January; 39: 263-270.

For example, the ML model 300 may be trained using supervised or unsupervised learning methods. Supervised learning methods may involve measuring the user's biosignals when the user 150 is instructed to give auditory attention to audio associated with each of a number of different audio sources, for example in turn, and/or to audio sources which have different respective positions with respect to the user.

The measured biosignals for different attention cases may be used to train the ML model 300 such that, during a subsequent inference phase, the ML model will classify received biosignals to a particular audio source or audio source position, thereby identifying the target audio source.

According to other example embodiments, which may or may not involve use of the ML model 300, another method for identifying the target audio source is to track and/or cross-correlate a user's biosignals with respective audio signals from different audio sources in the audio scene to identify a closest match.

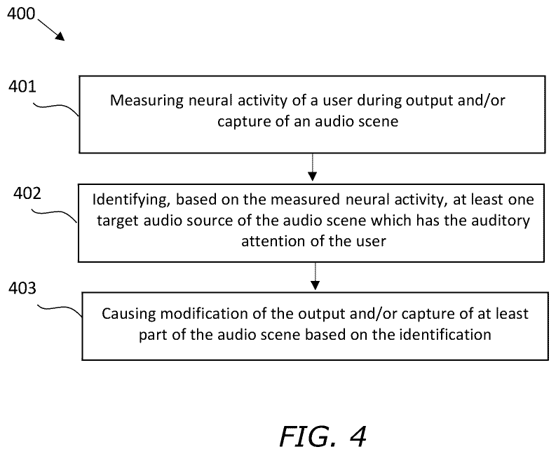

FIG. 4 is a flow diagram showing operations 400 according to one or more example embodiments. The operations 400 may be performed in hardware, software, firmware or a combination thereof. For example, the operations 400 may be performed individually, or collectively, by a means, wherein the means may comprise at least one processor and at least one memory storing instructions that, when executed by the at least one processor, cause the performance of the operations. The operations 400 may, for example, be performed by the processing module 230 which may be provided in the earphones device 140 or the user device 120.

A first operation 401 may comprise measuring neural activity of a user during output and/or capture of an audio scene.

A second operation 402 may comprise identifying, based on the measured neural activity, at least one target audio source of the audio scene which has the auditory attention of the user.

A third operation 403 may comprise causing modification of the output and/or capture of at least part of the audio scene based on the identification.

The first and second operations 401, 402 may be performed using one or more ML models and/or using tracking and/or cross-correlation methods as described above.

The third operation 403 may comprise one or more different modification options which will now be described with reference to particular examples.

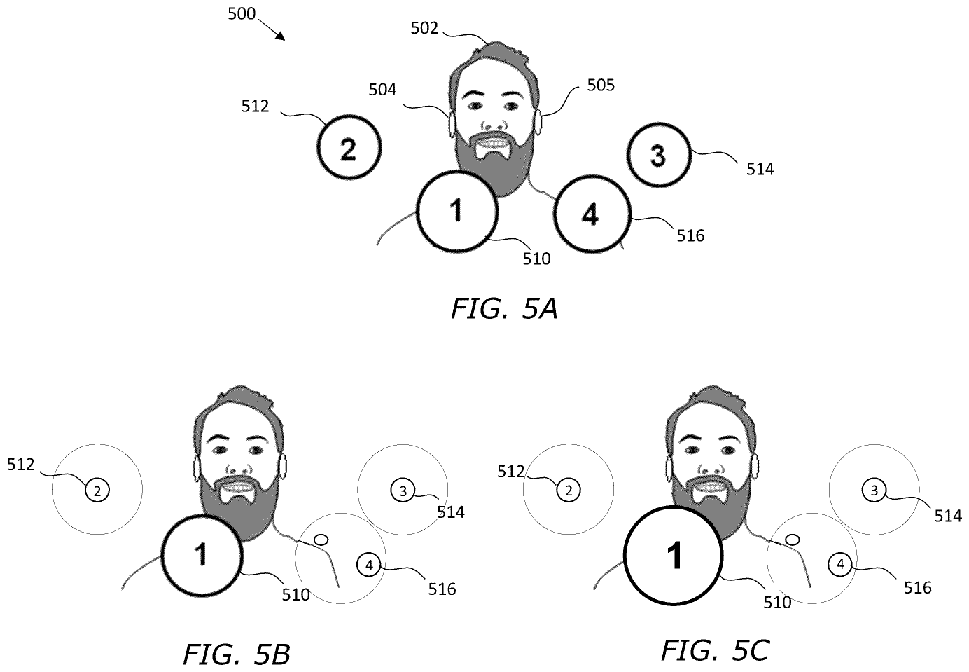

FIG. 5A illustrates a first scenario 500 in which a user 502 listens to audio data which is decoded and output as audio via an earphones device comprising first and second earphones 504, 505. At least one of the first and second earphones 504, 505 may correspond to that described in relation to FIG. 2A.

Audio data may comprise spatial audio data which represents an audio scene comprised of a plurality of audio sources 510, 512, 514, 516 having different respective positions with respect to the user 502.

The audio data may comprise part of a communications session in which the plurality of audio sources 510, 512, 514, 516 correspond to participants of the communications session.

In accordance with the first and second operations 401, 402 neural activity of the user 502 may be measured during output of the audio scene via the first and second earphones 504, 505.

A current target audio source may be identified based on the measured neural activity. For example, assume that a first audio source 510 has the user's auditory attention and is identified as the target audio source.

In accordance with the third operation 403, output of audio associated with (produced by) the first audio source 510 may be emphasized relative to audio signals associated with the other audio sources 512, 514, 516. This may involve amplifying audio associated with the first audio source 510 whilst keeping the gain of the audio of the other audio sources 512, 514, 516 unchanged. Alternatively, this may involve attenuating audio associated with the other audio sources 512, 514, 516 whilst keeping the gain of audio associated with of the first audio source 510 unchanged, as illustrated in FIG. 5B. Alternatively, this may involve both amplifying audio associated with the first audio source 510 and attenuating audio associated with the other audio sources 512, 514, 516, as illustrated in FIG. 5C. Additionally, or alternatively, modification may involve other effects such as reducing reverberation associated with the first audio source 510. As will be appreciated from the above, in some cases, the first audio source 510 may not be modified and the other audio sources 512, 514, 516 may be modified to de-emphasize or even remove their output and/or capture.

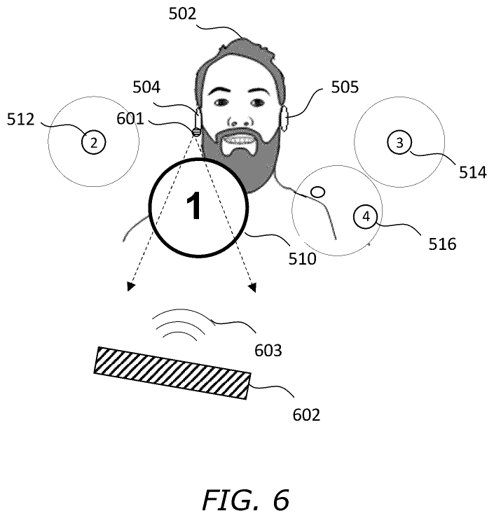

Referring to FIG. 6, the first earphones device 504 may also comprise a microphone 601 for capturing at least part of a real-world audio scene, which may include audio of the user's voice and/or other nearby audio.

In some scenarios, the real-world audio scene may comprise a background audio source 602, e.g., a computer, which may produce background audio 603 which comes from a corresponding direction to the position of the target audio source, in this case the first audio source 510.

The third operation 403 may alternatively or additionally comprise attenuating the background audio 603 based on its direction corresponding to the position of the first audio source 510. This may comprise using known ANC techniques for producing a noise cancellation signal which is output via the first and second earphones 504, 505.

In all such examples, it will be appreciated that the target audio source, in this case the first audio source 510, will be better perceived by the user 502.

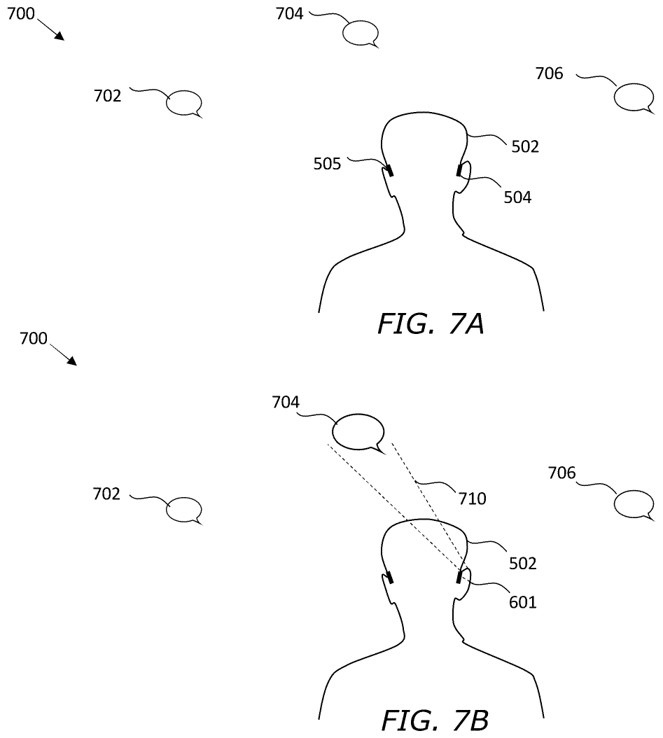

FIG. 7A illustrates a second scenario 700 in which the user 502 (seen from behind) listens to a real-world audio scene comprising a plurality of audio sources 702, 704, 706. The audio scene in this comprises the real-world audio scene.

The plurality of audio sources 702, 704, 706 have different respective positions with respect to the user 502. Audio associated with the plurality of audio sources 702, 704, 706 may be captured via one or more microphones, for example via the microphone 601 of the first earphone 504 or via one or more microphones (not shown) on another capture device, such as one or more microphones of the user device 120 and/or of the second earphone 505.

In this respect, the first earphone 504 (and the second earphone 505, if provided) may comprise a hearing aid or earphone with an associated accessibility function.

In accordance with the first and second operations 401, 402, neural activity of the user 502 may be measured during capture of the audio scene. A current target audio source may be identified based on the measured neural activity. For example, assume that a second audio source 704 has the user's auditory attention and is identified as the target audio source with an associated direction with respect to the user 502.

In accordance with the third operation 403, capture of the second audio source 704 may be modified.

As illustrated in FIG. 7B, the microphone 601 may comprise a beamforming microphone for providing, or steering, a sound capture beam 710 towards the determined direction of the second audio source 704 such as to amplify captured audio coming from the direction of the second audio source 704. Audio coming from other direction(s) may not be captured or may be captured with less gain than for the audio coming from the direction of the second audio source 704.

It will be appreciated that the target audio source, in this case the second audio source 704, will be better perceived by the user 502.

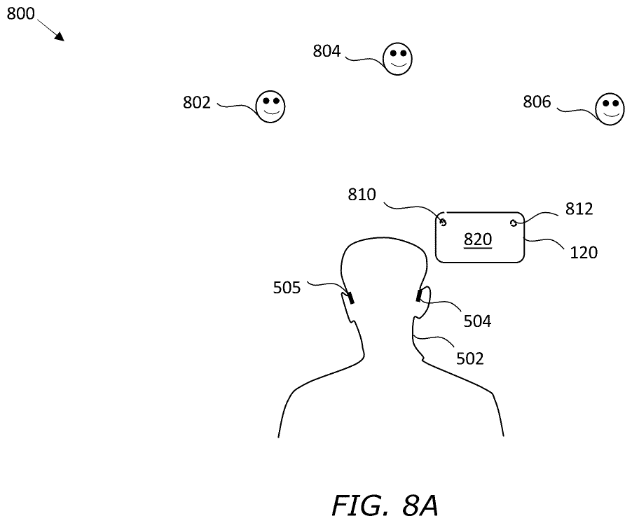

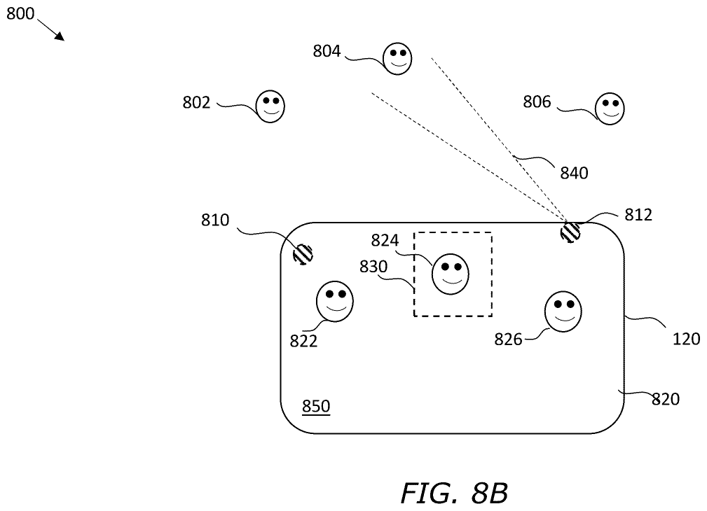

FIG. 8A illustrates a third scenario 800 in which the user 502 operates image capture functionality of the user device 120 whilst listening to a real-world audio scene comprising a plurality of audio sources 802, 804, 806. The plurality of audio sources 802, 804, 806 have different respective positions with respect to the user 502 as shown.

The user device 120 may comprise a camera 810 and a display screen 820. The camera 810 may be configured to capture one or a plurality of images (i.e., sequential images of a video clip). The user device 120 may also provide a camera application for handling certain camera-related functions such as controlling image or video focus by means of adjusting one or more lenses of the camera and/or selecting which lens(es) to use. The user device 120 may also comprise one or more microphones 812 for spatial capture of at least part of the real-world audio scene. Said microphones 812 may use beamforming as mentioned above to amplify audio coming from one or more particular directions. Referring to FIG. 8B, the user device 120 displays to the display screen 820 a viewfinder image 850 showing respective image sub-portions 822, 824, 826 which correspond to the audio sources 802, 804, 806.

It may be assumed that the neural activity of the user 502 is measured during video and audio capture. The user 502 may, for example, wear the first and second earphones 504, 505 for this purpose wherein the neural activity of the user 502 may be picked-up by sensors of, for example, the first earphone 504 and transmitted as EEG data to the user device 120. In accordance with the first and second operations 401, 402 neural activity of the user 502 may be measured during capture of viewfinder image by the camera 810. A current target audio source may be identified based on the measured neural activity. For example, assume that a second audio source 804 has the user's auditory attention and is identified as the target audio source and its direction with respect to the user 502 or the user device 120 may be determined.

In accordance with the third operation 403, capture of the second audio source 804 may be modified.

For example, the microphone 812 of the user device 120 may provide, or steer, a sound capture beam 840 towards the determined direction of the second audio source 804 such as to amplify captured audio coming from the direction of the second audio source 804.

For example, the camera application of the user device 120 may focus (in terms of audio and/or video capture) on a sub-portion 830 of the image or sequential images based on the direction of the second audio source 804 with respect to the user 502 or of the user device 120. The sub-portion 830 will correspond to the second audio source 804.

For example, the camera application of the user device 120 may alternatively or additionally indicate the sub-portion 830, for example with a bounding box or similar, to inform the user that the audio and video focus is on the second audio source 804.

For example, the camera application of the user device 120 may alternatively or additionally change which lens is used to capture the second audio source 804, for example where a different lens will provide better video focus on the second audio source.

In some example embodiments, not shown in FIG. 8B, it may be determined, based on the direction of the target audio source, that the viewfinder image 850 does not include the target audio source. In other words, the target audio source is not being captured by the camera 810. In this case, the camera application of the user device 120 may change the lens such that the target audio source will be captured by the camera 810, for example by selecting a wider-angle lens, e.g., from a current “2×” lens to a “0.5×” lens.

Where both audio and video modification are used, therefore, a resulting video clip comprising sequential images will have improved video and audio clarity in relation to the second audio source 804.

In some example embodiments, the FIG. 4 operations 400 (or at least the third operation 403) may be performed responsive to identification of a predetermined trigger gesture of the user 502.

A further operation may therefore comprise identifying a predetermined trigger gesture of the user 502 and performing at least the third operation 403 responsive to identifying a predetermined trigger gesture.

For example, the predetermined trigger gesture may be identified based at least in part of the measured neural activity of the user 502 when said predetermined trigger gesture is performed. For example, the above-mentioned ML model 300, or a different ML model, may be trained using biosignals measured when the user 502 is prompted to perform the predetermined trigger gesture as part of a training phase. Thereafter, the ML model 300 in an inference phase (in use) may perform, or cause performance of, at least the third operation 403 responsive to receiving the same or similar biosignals which it identifies as the predetermined trigger gesture.

In some example embodiments, the predetermined trigger gesture may comprise a physical movement of part of the user's body, such as a predetermined type of eye movement which may comprise eye movement in a particular direction and/or blinking at an above-threshold rate (e.g., greater than three blinks per second). In some example embodiments, additional or alternative to measuring EEGs, measurement of the biosignals may comprise measuring electrooculograms (EOG) which represent the “corneal-retinal” standing potential that exists between the front and back of the human eye. In some example embodiments, another pair of sensors may therefore be provided, for example sensors which contact the user's skin above and below at least one eye, or alternatively either side of said at least one eye. Said sensors may for example be carried by a set of glasses or goggles adapted for this purpose and which may be configured to communicate with the first earphone 200 or the user device 120. Additionally, or alternatively, one or more optical sensors, e.g., cameras, may capture movement of the user's eyes and communicate measurements to the first earphone 200 or the user device 120.

In some example embodiments, further operations may comprise determining a confidence value associated with identifying the target audio source. For example, the ML model 300 may output respective confidence values associated with the plurality of audio sources, wherein the confidence value associated with a particular audio source indicates a likelihood that the particular audio source has the auditory attention of the user. For example, the ML model 300 may output a confidence value (or score) for each of the plurality of audio sources in the audio scene and selects the audio source with the highest confidence value as the target audio source. However, predetermined criteria may require that the highest confidence value be above a predetermined threshold, e.g., above 60%, to identify the relevant audio source as the target audio source. Additionally, or alternatively, the predetermined criteria may require that the highest confidence value be a certain amount higher than the next-highest confidence value, e.g., at least 15% higher. If said criteria are not met, an ambiguity may be identified between two or more audio sources. This may occur, for example, because the two or more audio sources have overlapping frequency bands and/or are outputting audio at overlapping times. In the case of an identified ambiguity, example embodiments may further comprise resolving the ambiguity based on further measured neural activity to identify which audio source is the target audio source. For example, the user 502 may be prompted to feedback which of the audio sources is the target audio source to remove ambiguity. For example, the user may be promoted via an audible sound, a spoken message and/or a haptic output.

For example, with reference to FIG. 5A, the ML model 300 may determine that the first audio source 510 is identified in the second operation 402 with a confidence value of 70% and the next-highest confidence value is 20% for the second audio source 512, in which case there is no ambiguity. However, if the first audio source 510 has a confidence value of 55% and the next-highest value is 45% for the second audio source 512, then an ambiguity may be identified which needs to be resolved. For example, the user 502 may be requested to provide a directional gesture towards the target audio source. Assuming the first audio source 510 has the user's attention, the user 502 may make a directional gesture towards the first audio source 510. The directional gesture may comprise moving a body part, such as the user 502 moving their eyes left or rightwards towards the first audio source. The directional gesture may be determined based on the measured neural activity of the user 502 in a similar manner as described above for the predetermined trigger gesture. In another example, a reference sound may be output in the direction of at least one of the first and second audio sources 510, 512. In some examples, different respective reference sounds (having different audio characteristics) may be output at the respective directions of the first and second audio sources 510, 512. The user's neural activity is measured when the reference sound(s) are output and the ambiguity may be resolved, for example because it is expected that the respective confidence values of the first and second audio sources 510, 512 will move further apart such that there will be at least 15% (or some other threshold range) difference between the confidence values. This method may be additional, or alternative, to the requesting of a directional gesture for resolving the ambiguity. In some example embodiments, another operation may comprise measuring, based on the measured neural activity, a time period over which the target audio source has the auditory attention of the user 502. The modifying in this example may be performed based on the measured time period. For example, the amount of modification may be determined based on the measured time period. For example, the longer the user's auditory attention is on the target audio source, the more gain is applied in amplifying audio associated with the target audio source, possibly up to a predetermined gain limit.

As described, the FIG. 4 operations 400 may be performed by an earphones device comprising one or more sensors for picking-up biosignals of the user for measuring the user's neural activity. Alternatively, the FIG. 4 operations 400 may be performed by a user device in communication with an earphones device, wherein the earphones device comprises one or more sensors for picking-up biosignals of the user for measuring the user's neural activity, which biosignals are transmitted to the user device.

### Example Apparatus

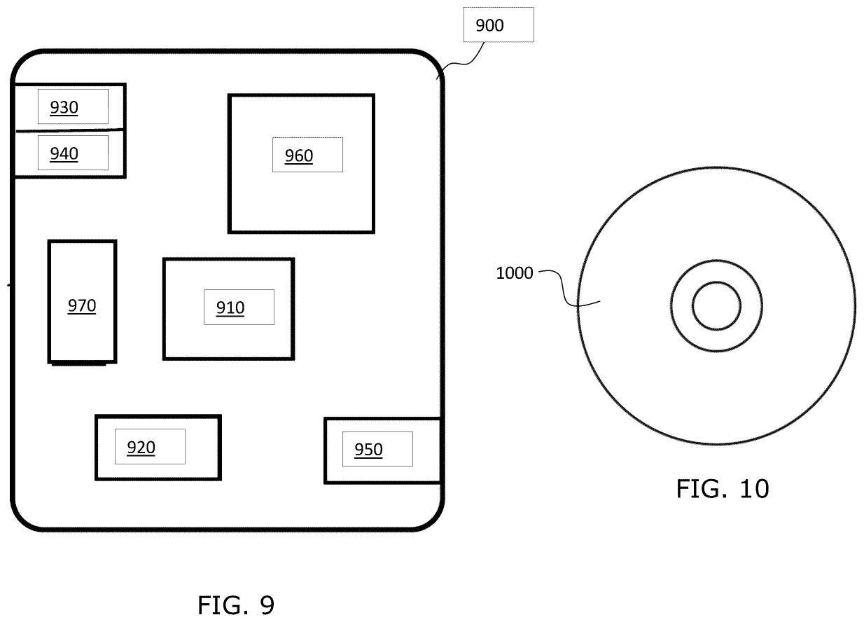

FIG. 9 illustrates an example apparatus 900 capable of supporting at least some embodiments. Illustrated is a device 900, which may comprise an earphones device, e.g., the first earphone 200, or the user device 120. Comprised in device 900 is a processor 910, which may comprise, for example, a single-or multi-core processor wherein a single-core processor comprises one processing core and a multi-core processor comprises more than one processing core. The processor 910 may comprise, in general, a control device. The processor 910 may comprise more than one processor. The processor 910 may be a control device. A processing core may comprise, for example, a Cortex-A8 processing core manufactured by ARM Holdings or a Steamroller processing core produced by Advanced Micro Devices Corporation. The processor 910 may comprise at least one Qualcomm Snapdragon and/or Intel Atom processor. The processor 910 may comprise at least one Application-Specific Integrated Circuit, ASIC. The processor 910 may comprise at least one Field-Programmable Gate Array, FPGA. The processor 910 may be means for performing method steps in device 900. The processor 910 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, or a device configured to control the functioning thereof, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The device 900 may comprise a memory 920. The memory 920 may comprise random access memory and/or permanent memory. The memory 920 may comprise at least one RAM chip. The memory 920 may comprise solid-state, magnetic, optical and/or holographic memory, for example. The memory 920 may be at least in part accessible to processor 910. The memory 920 may be at least in part comprised in processor 910. The memory 920 may be means for storing information. The memory 920 may comprise computer instructions that processor 910 is configured to execute. When computer instructions configured to cause the processor 910 to perform certain actions are stored in the memory 920, and the device 900 overall is configured to run under the direction of the processor 910 using computer instructions from the memory 920, the processor 910 and/or its at least one processing core may be considered to be configured to perform said certain actions. The memory 920 may be at least in part comprised in the processor 910. The memory 920 may be at least in part external to the device 900 but accessible to the device 900.

The device 900 may comprise a transmitter 930. The device 900 may comprise a receiver 940. The transmitter 930 and the receiver 940 may be configured to transmit and receive, respectively, information in accordance with at least one cellular or non-cellular standard.

The transmitter 930 may comprise more than one transmitter. The receiver 940 may comprise more than one receiver. The transmitter 930 and/or the receiver 940 may be configured to operate in accordance with Global System for Mobile Communication, GSM, Wideband Code Division Multiple Access, WCDMA, 5G/NR, 5G-Advanced, i.e., NR Rel-18, 19 and beyond, Long Term Evolution, LTE, IS-95, Wireless Local Area Network, WLAN, Ethernet and/or Worldwide Interoperability for Microwave Access, WiMAX, standards, for example.

The device 900 may comprise a Near-Field Communication, NFC, transceiver 950. The NFC transceiver 950 may support at least one NFC technology, such as NFC, Bluetooth, Wibree or similar technologies.

The device 900 may comprise a User Interface, UI, 960. The UI 960 may comprise at least one of a display, a keyboard, a touchscreen, a vibrator arranged to signal to a user by causing device 900 to vibrate, a speaker and a microphone. A user may be able to operate the device 900 via the UI 960, for example to accept incoming telephone calls, to originate telephone calls or video calls, to browse the Internet, to manage digital files stored in memory 920 or on a cloud accessible via the transmitter 930 and the receiver 940, or via NFC transceiver 950, and/or to play games.

The device 900 may comprise or be arranged to accept a user identity module 970. The user identity module 970 may comprise, for example, a Subscriber Identity Module, SIM, card installable in device 900. The user identity module 970 may comprise information identifying a subscription of a user of device 900. The user identity module 970 may comprise cryptographic information usable to verify the identity of a user of device 900 and/or to facilitate encryption of communicated information and billing of the user of the device 900 for communication effected via device 900.

The processor 910 may be furnished with a transmitter arranged to output information from processor 910, via electrical leads internal to the device 900, to other devices comprised in the device 900. Such a transmitter may comprise a serial bus transmitter arranged to, for example, output information via at least one electrical lead to the memory 920 for storage therein. Alternatively to a serial bus, the transmitter may comprise a parallel bus transmitter.

Likewise, the processor 910 may comprise a receiver arranged to receive information in The processor 910, via electrical leads internal to the device 900, from other devices comprised in the device 900. Such a receiver may comprise a serial bus receiver arranged to, for example, receive information via at least one electrical lead from the receiver 940 for processing in the processor 910. Alternatively to a serial bus, the receiver may comprise a parallel bus receiver.

The device 900 may comprise further devices not illustrated in FIG. 9. For example, where the device 900 comprises a smartphone, it may comprise at least one digital camera. Some devices 900 may comprise a back-facing camera and a front-facing camera, wherein the back-facing camera may be intended for digital photography and the front-facing camera for video telephony. The device 900 may comprise a fingerprint sensor arranged to authenticate, at least in part, a user of the device 900. In some embodiments, the device 900 lacks at least one device described above. For example, some devices 900 may lack a NFC transceiver 950 and/or user identity module 970.

The processor 910, memory 920, transmitter 930, receiver 940, NFC transceiver 950, UI 960 and/or user identity module 970 may be interconnected by electrical leads internal to the device 900 in a multitude of different ways. For example, each of the aforementioned devices may be separately connected to a master bus internal to the device 900, to allow for the devices to exchange information. However, as the skilled person will appreciate, this is only one example and depending on the embodiment various ways of interconnecting at least two of the aforementioned devices may be selected without departing from the scope of the present invention.

FIG. 10 shows a non-transitory media 1000 according to some embodiments. The non-transitory media 1000 is a computer readable storage medium. It may be e.g. a CD, a DVD, a USB stick, a blue ray disk, etc. The non-transitory media 1000 stores computer program instructions, causing an apparatus to perform the method of any preceding process for example as disclosed in relation to the flow diagrams in this specification and related features thereof.

The described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in dependant claims are mutually freely combinable unless otherwise explicitly stated. Furthermore, it is to be understood that the use of “a” or “an”, that is, a singular form, throughout this document does not exclude a plurality.

1-25. (canceled)

26. An apparatus, comprising:
at least one processor; and
at least one memory storing instructions that, when executed by the at least one processor, cause the apparatus at least to:
measure neural activity of a user during at least one of output or capture of an audio scene;
identify, based on the measured neural activity, at least one target audio source of the audio scene which has the auditory attention of the user; and
cause modification of the at least one of output or capture of at least part of the audio scene based on the identification.

27. The apparatus of claim 26, wherein
the modifying comprises, during output of the audio scene, emphasizing output of audio associated with the at least one target audio source relative to audio associated with one or more other audio sources of the audio scene.

28. The apparatus of claim 27, wherein
the emphasizing comprises amplifying the audio associated with the at least one target audio source relative to the audio associated with the one or more other audio sources of the audio scene.

29. The apparatus of claim 27, wherein
the emphasizing comprises attenuating the audio associated with the one or more other audio sources relative to the audio associated with the at least one target audio source of the audio scene.

30. The apparatus of claim 26, wherein
the audio scene comprises a plurality of audio sources and wherein audio associated with the plurality of audio sources is output such that the audio sources will be perceived at different respective positions with respect to the user.

31. The apparatus of claim 30, wherein
the modifying comprises, during output of the audio scene, attenuating audio associated with a background audio source in a direction which corresponds to the position of the at least one target audio source.

32. The apparatus of claim 31, wherein
the audio associated with the background audio source is captured by the apparatus or a capture device associated with the apparatus during output of the audio scene.

33. The apparatus of claim 26, wherein
the audio scene comprises a plurality of audio sources and is received as part of a communications session in which the plurality of audio sources represents respective participants of the communications session.

34. The apparatus of claim 26, wherein
the audio scene is a real-world audio scene in which audio associated with one or more audio sources of the audio scene is captured by the apparatus or a capture device associated with the apparatus.

35. The apparatus of claim 34, wherein the apparatus is further caused to:
determine, during capture, a direction of the at least one target audio source with respect to the user,
wherein the modifying comprises providing or steering a sound capture beam towards the direction of the at least one target audio source such as to amplify audio coming from the direction of the at least one target audio source relative to audio coming from the direction of one or more other audio sources of the real-world audio scene.

36. The apparatus of claim 35, wherein the apparatus is further caused to:
capture, via a camera of the apparatus, an image of the real-world audio scene;
display the captured image;
determine, based on the direction of the at least one target audio source with respect to the user, a sub-portion of the captured image corresponding to the at least one target audio source; and
modify the determined sub-portion or cause the camera to focus on the determined sub-portion.

37. The apparatus of claim 35, wherein the apparatus is further caused to:
capture, via a camera of the apparatus, an image of the real-world audio scene;
display the captured image;
determine, based on the direction of the at least one target audio source with respect to the user, that the captured image does not include the at least one target audio source; and
change a lens of the camera such that the captured image will include the at least one target audio source.

38. The apparatus of claim 26, wherein the apparatus is further caused to:
identify a predetermined trigger gesture of the user,
wherein at least the modifying is performed responsive to identifying the predetermined trigger gesture, and
wherein the predetermined trigger gesture is identified based at least in part on the measured neural activity of the user when said predetermined trigger gesture is performed.

39. The apparatus of claim 26, wherein the apparatus is further caused to:
determine respective confidence values associated with a plurality of audio sources of the audio scene, wherein the confidence value associated with a particular audio source indicates a likelihood that the particular audio source has the auditory attention of the user,
wherein the at least one target audio source is identified, based at least in part, on the respective confidence values.

40. The apparatus of claim 39, wherein the apparatus is further caused to:
identify an ambiguity between two or more of the audio sources having the highest respective confidence values based on said respective confidence values being within a predetermined range of one another; and
resolve the ambiguity based on further measured neural activity to identify which of the two or more identified audio sources is the target audio source.

41. The apparatus of claim 40, wherein the apparatus is further caused to:
responsive to identifying the ambiguity, output a reference sound in the direction of at least one of the two or more identified audio sources,
wherein resolving the ambiguity comprises identifying, based on measured neural activity when the reference sound is played to the user, which of the two or more identified audio sources is the target audio source.

42. The apparatus of claim 40, wherein the apparatus is further caused to:
responsive to identifying the ambiguity, request a directional gesture towards the position of the target audio source,
wherein the directional gesture is determined based on the measured neural activity of the user when said directional gesture is performed.

43. The apparatus of claim 26, wherein
the apparatus is comprised by an earphones device comprising one or more sensors for sensing biosignals of the user for measuring the user's neural activity, or
the apparatus is comprised by a user device in communication with an earphones device.

44. A method, comprising
measuring neural activity of a user during at least one of output or capture of an audio scene;
identifying, based on the measured neural activity, at least one target audio source of the audio scene which has the auditory attention of the user; and
causing modification of the at least one of output or capture of at least part of the audio scene based on the identification.

45. A non-transitory computer readable medium comprising program instructions stored thereon for performing at least the following:
measuring neural activity of a user during at least one of output or capture of an audio scene;
identifying, based on the measured neural activity, at least one target audio source of the audio scene which has the auditory attention of the user; and
causing modification of the at least one of output or capture of at least part of the audio scene based on the identification.
